(19) United States
(12) Patent Application Publication
(10) Pub. No.: US 2026/0105739 A1
(43) Pub. Date: Apr. 16, 2026

(54) TASK-ORIENTED COMMUNICATION SYSTEM AND METHOD BASED ON ADAPTIVE FEATURE COMPRESSION FOR EFFICIENT MULTIMEDIA COMMUNICATION SERVICE

(71) Applicant: KWANGWOON UNIVERSITY INDUSTRY-ACADEMIC COLLABORATION FOUNDATION, Seoul (KR)

(72) Inventors: Jin Young KIM, Seoul (KR); Joonho SEON, Uiwang-si (KR); Seongwoo LEE, Seoul (KR); Soo Hyun KIM, Gapyeong-gun (KR); Young Ghyu SUN, Seoul (KR)

(73) Assignee: KWANGWOON UNIVERSITY INDUSTRY-ACADEMIC COLLABORATION FOUNDATION, Seoul (KR)

(21) Appl. No.: 19/305,480

(22) Filed: Aug. 20, 2025

(30) Foreign Application Priority Data
Oct. 14, 2024 (KR) 10-2024-0139533

(51) Int. Cl. G06V 10/82; G06V 10/764; G06V 10/77; G06V 10/94

(52) U.S. Cl. CPC G06V 10/82; G06V 10/764; G06V 10/7715; G06V 10/95

(57) ABSTRACT

A task-oriented communication system according to the present disclosure includes a task-oriented transmitter, a task-oriented receiver, and a learning unit. The task-oriented transmitter includes an input unit which receives image data, an extraction unit which extracts a feature map from the image data using a convolutional neural network, a compression unit which compresses the feature map at a selected compression rate, and a transmitter which transmits the compressed feature map to the task-oriented receiver, the task-oriented receiver includes an inference unit which classifies a class label using a classification model trained from the compressed feature map and a transmitter which transmits a class label classification result to the task-oriented transmitter. The learning unit trains a reinforcement learning model for selecting a compression rate and the compression unit selects the compression rate using the trained reinforcement learning model.

### BACKGROUND

### Field

The present disclosure relates to a task-oriented communication system and method for a multimedia communication service, and more particularly, to a task-oriented communication system and method which collect image data, extract a feature map from image data, and compress the feature map at a transmission end to transmit the feature map to a receiving end, and perform classification and the task using the corresponding information at the receiving end.

### Description of the Related Art

Recently, in 6G communication, a task-oriented communication system which receives single or continuous image data to perform efficient inference is attracting attention as an efficient technology compared with the existing communication system. Specifically, as a data demand for multimedia services is increased, the task-oriented communication system is actively being studied as a technology for providing an efficient communication service in an edge computing apparatus which are sensitive to delay.

Existing deep learning models which have been developed for 6G communication integrate semantic segmentation and edge preservation technologies into image transmission to improve bandwidth efficiency and noise resilience. However, according to the existing methods, features are compressed to a fixed length for transmission. Further, in most of the studies on the feature compression which has been proposed recently, static feature compression is adopted or adaptive feature selection depending on an arbitrary threshold which requires expert knowledge is utilized. Accordingly, a new approach is demanded for a task-oriented communication system which dynamically compresses a feature without the expert knowledge.

### RELATED ART DOCUMENT

### Non-Patent Documents

(Non-Patent Document 1) Y. Shi, Y. Zhou, D. Wen, Y. Wu, C. Jiang and K. B. Letaief, “Task-oriented communications for 6G: Vision, principles, and technologies,” IEEE Wirel. Comm., vol. 30, no. 3, pp. 78 to 85, June 2023.

### SUMMARY

An object to be achieved by the present disclosure is to provide a task-oriented communication system based on adaptive feature compression for a high efficient multimedia communication system which adaptively compresses a feature map extracted from image data collected at a transmission end using a reinforcement learning model which has been trained in advance and transmits the feature map to a reception end and performs a task using the compressed feature map received in the reception end to save a communication cost and more efficiently perform the signal transmission and the task while ensuring an inference performance of the system and a method thereof.

The technical object to be achieved by the present disclosure is not limited to the above-mentioned technical objects, and other technical objects, which are not mentioned above, can be clearly understood by those skilled in the art from the following descriptions.

In order to achieve the above-described technical object, according to an aspect of the present disclosure, a task-oriented communication system includes a task-oriented transmitter, a task-oriented receiver, and a learning unit. The task-oriented transmitter includes an input unit which receives image data; an extraction unit which extracts a feature map from the image data using a convolutional neural network; a compression unit which compresses the feature map at a selected compression rate; and a transmitter which transmits the compressed feature map to the task-oriented receiver, the task-oriented receiver includes: an inference unit which classifies a class label using a classification model trained from the compressed feature map; and a transmitter which transmits a class label classification result to the task-oriented transmitter, the learning unit trains a reinforcement learning model for selecting a compression rate, and the compression unit selects the compression rate using the trained reinforcement learning model.

The reinforcement learning model includes an agent which selects a compression rate using an input feature map and an environment module which estimates an inference accuracy based on a feature map compressed at a compression rate selected by the agent to transmit a reward to the agent.

The agent is trained based on the reward transmitted from the environment module using training errors of the actor and the critic.

The loss function of the actor is calculated by the following Equation.

$${L}_{A} ( θ ) = - {E}_{\text{?}} \vert log {π}_{\text{?}} ( a \vert s ) {A}^{\text{?}} ( s , a ) \vert$$

$$\text{?} \text{indicates text missing or illegible when filed}$$

Here, L_{A}(θ) is a loss function of the actor, [symbol] is a policy which is targeted by the actor, and [symbol] is a gain function parameterized under [symbol] .

The loss function of the critic is calculated by the following Equation.

$${L}_{C} ( ϕ ) = {E}_{\text{?}} \vert {( {R}_{t} + γ V ( {s}_{t + 1} , ϕ ) - V ( {s}_{\text{?}} , ϕ ) )}^{2} \vert$$

$$\text{?} \text{indicates text missing or illegible when filed}$$

Here, L_{C}(φ) is a loss function of a critic parameterized with φ, Rₜ is a reward at a timing t, γ is a discount factor, V(sₜ₊₁; φ′) is a value of a next state estimated by a target network, V(sₜ,φ) is a value of a current state.

The reward is calculated by the following Equation.

$$R = [ \begin{matrix}\frac{1}{m} {\sum }_{i = 1}^{m} {( 1 - {\text{?}}_{i} )}^{2} , & y = \hat{y} \\ ρ , & otherwise\end{matrix} ]$$

$$\text{?} \text{indicates text missing or illegible when filed}$$

Here, R is the reward, m is a size of a data batch, a is an action taken by the agent, y is a class label, ŷ is a predicted class label, and ρ is a penalty value.

The learning unit is provided in an edge server.

In order to achieve the above-described technical object, according to another aspect of the present disclosure, an operation method of a task-oriented communication system which includes a task-oriented transmitter, a task-oriented receiver, and a learning unit, includes the steps of: receiving image data by the task-oriented transmitter; extracting a feature map from the image data using a convolutional neural network; compressing the feature map at a selected compression rate; transmitting the compressed feature map to the task-oriented receiver; classifying a class label using a classification model trained from the compressed feature map by the task-oriented receiver; and transmitting a class label classification result to the task-oriented transmitter, the learning unit trains a reinforcement learning model for selecting a compression rate, and in the compressing step, the compression rate is selected using the trained reinforcement learning model.

The reinforcement learning model includes an agent which selects a compression rate using an input feature map and an environment module which estimates an inference accuracy based on a feature map compressed at a compression rate selected by the agent to transmit a reward to the agent.

The agent is trained based on the reward transmitted from the environment module using training errors of the actor and the critic.

In order to achieve the above-described technical object, according to another aspect of the present disclosure, a computer program is stored in a computer readable storage medium to allow a computer to execute the operation method of the above-described task-oriented communication system.

In order to achieve the above-described technical object, according to another aspect of the present disclosure, a task-oriented transmitter of a task-oriented communication system includes a processor and a memory in which a program executed by the processor is stored. The processor is configured to receive image data, extract a feature map from the image data using a convolutional neural network, train a reinforcement learning model for selecting a compression rate, select a compression rate using the trained reinforcement learning model, compress the feature map at the selected compression rate, transmit the compressed feature map to the task-oriented receiver, classify a class label using a classification model trained from the compressed feature map by the task-oriented receiver, and receive the class label classification result when the class label classification result is transmitted.

According to the present disclosure, a feature map extracted from image data which is collected at a transmission end is adaptively compressed using a previously trained reinforcement learning model and is transmitted to a reception end and a task is performed using the compressed feature map received from the reception end, thereby saving a communication cost and more efficiently performing signal transmission and the task while ensuring an inference performance of the system. Further, a latency time required for the communication is reduced and the inference performance is maintained to improve a quality of experience (QoE) of a user.

Effects of the present disclosure are not limited to the above-mentioned effects, and other effects, which are not mentioned above, can be clearly understood by those skilled in the art from the following descriptions.

### BRIEF DESCRIPTION OF DRAWINGS

FIG. 1 is a block diagram of a task-oriented communication system based on adaptive feature compression for a high efficient multimedia communication service, according to an exemplary embodiment of the present disclosure;

FIG. 2 illustrates a configuration and an operation of a reinforcement learning model of a learning unit according to an exemplary embodiment of the present disclosure;

FIG. 3 is a flowchart of an operation method of a task-oriented communication system based on adaptive feature compression for a high efficient multimedia communication service, according to an exemplary embodiment of the present disclosure; and

FIG. 4 is a block diagram of a task-oriented transmitter of a task-oriented communication system based on adaptive feature compression for a high efficient multimedia communication service, according to another exemplary embodiment of the present disclosure.

### DETAILED DESCRIPTION OF THE EMBODIMENT

Hereinafter, exemplary embodiments of the present disclosure will be described in detail with reference to the drawings. Substantially same components in the following description and the accompanying drawings may be denoted by the same reference numerals so that a redundant description will be omitted. Further, in the description of the exemplary embodiment, if it is considered that specific description of related known configuration or function may cloud the gist of the present disclosure, the detailed description thereof will be omitted.

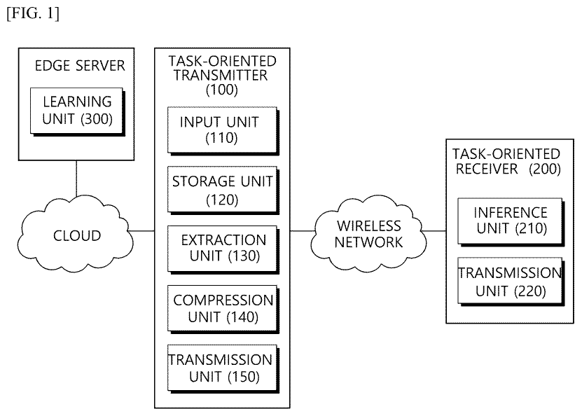

FIG. 1 is a block diagram of a task-oriented communication system based on adaptive feature compression for a high efficient multimedia communication service, according to an exemplary embodiment of the present disclosure.

Referring to FIG. 1, a task-oriented communication system according to the exemplary embodiment includes a task-oriented transmitter 100, a task-oriented receiver 200, and a learning unit 300. The task-oriented transmitter 100 is a user terminal, such as a mobile or edge computing terminal. The task-oriented receiver 200 may be an inference server. The task-oriented transmitter 100 and the task-oriented receiver 200 are connected to each other through a wireless network. The wireless network is configured by a 6G communication system.

The learning unit 300 may be provided in an edge server. The task-oriented transmitter 100 and the learning unit 300 are connected through a cloud. According to the exemplary embodiment, the learning unit 300 may be provided in the task-oriented transmitter 100.

The task-oriented transmitter 100 receives and stores image data through a terminal sensor or a multimedia application, trains a reinforcement learning model using the stored image data by the learning unit 300, extracts a feature map from the image data, dynamically compresses the feature map using the trained reinforcement learning model, and transmits the compressed feature map to the task-oriented receiver 200 through a wireless network.

The task-oriented receiver 200 performs classification and the task using the compressed feature map which is received from the task-oriented transmitter 100 and transmits the classification and task performing results to the task-oriented transmitter 100 through the wireless network.

The task-oriented transmitter 100 includes an input unit 110, a storage unit 120, an extraction unit 130, a compression unit 140, and a transmission unit 150.

The task-oriented receiver 200 includes an inference unit 210 and a transmission unit 220.

The input unit 110 receives image data through the terminal sensor or the multimedia application. The image data may be a single image or a continuous image (for example, a moving image).

The storage unit 120 stores image data input through the input unit 110. The stored image data is transmitted to the learning unit 300 of the edge server through the cloud.

The extraction unit 130 extracts the feature map from the input data input through the input unit 110 using a convolutional neural network. Here, the convolutional neural network may configure an encoder of an auto-encoder model.

The extraction unit 130 uses the convolutional neural network model to extract the feature map and as a loss function for training the convolutional neural network model, a loss function according to the following Equation may be used.

$${L}_{\text{?}} = - \frac{1}{N} {\sum }_{n = \text{?}}^{\text{?}} {\sum }_{\text{?} = 1}^{\text{?}} {y}_{n , i} log ( {\hat{y}}_{n , i} ) \qquad [ Equation 1 ]$$

$$\text{?} \text{indicates text missing or illegible when filed}$$

Here, L_{cls} is a loss function of the convolutional neural network model, N is a size of a data batch, C is a number of class labels, y_{n, i} is a class label, and [symbol] is a predicted class label. Referring to Equation 1, this is a model for task-oriented communication so that the loss function is configured based on a cross entropy (CE) function, rather than a mean squared error (MSE) function for reconstruction.

The learning unit 300 constructs and trains the reinforcement learning model for selecting a compression rate using the image data transmitted from the storage unit 120.

The compression unit 140 selects the compression rate using the reinforcement learning model trained by the learning unit 300 and compresses the feature map at the selected compression rate.

The transmitter 140 transmits the compressed feature map to the task-oriented receiver 200 through the wireless network.

The inference unit 210 performs a predetermined task to classify class labels using a classification model trained from the compressed feature map transmitted from the task-oriented transmitter 100.

The transmitter 120 transmits the class label classification result and the task performing result to the transmitter 100.

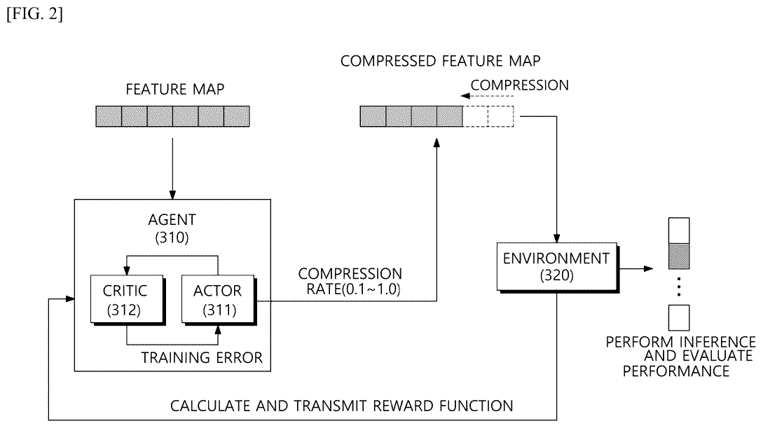

FIG. 2 illustrates a configuration and an operation of a reinforcement learning model of a learning unit 300 according to an exemplary embodiment of the present disclosure.

The learning unit 300 selects the compression rate from the feature map using a deep reinforcement learning algorithm to learn a dynamic compression action for maintaining a task performing accuracy while saving a communication cost. Here, the reinforcement learning algorithm is implemented by advantage actor critic (A2C), but is not necessarily limited thereto, and another reinforcement learning algorithm may be adopted. However, in the following exemplary embodiment, an example which is implemented by the A2C algorithm will be described.

Referring to FIG. 2, the reinforcement learning model includes an agent 310 and an environment module 320.

The agent 310 selects the compression rate using the input feature map and compresses the feature map. Here, the compression rate has a value between 0.1 and 1.0 so that the larger the value, the higher the compression rate. When the compression rate is 1.0, the compression is not performed at all. The environment module 320 estimates an inference accuracy based on a feature map which is compressed at a compression rate selected by the agent 310 to transmit a reward to the agent 310. Here, the reward means a calculation equation for maximizing the inference accuracy while minimizing the compression rate and is calculated using Equation 6.

The agent 310 is trained using a training loss of an actor 311 and a critic 312 based on the reward transmitted from the environment module 320. The training error is calculated based on the computation with the inference accuracy estimated based on the compression rate selected by the actor 311 and a value determined by the critic 312. In order to reduce the training error, the actor 311 gradually selects the smallest possible compression rate while maintaining task performance accuracy from the feature map. By means of a training process as described above, finally, the trained actor 311 obtains an ability to select an optimal compression rate from the feature map.

The loss function of the actor 311 is calculated by the following Equation.

$${L}_{A} ( θ ) = - {E}_{\text{?}} \vert log {π}_{\text{?}} ( a \vert s ) {A}^{\text{?}} ( s , a ) \vert \qquad [ Equation 2 ]$$

$$\text{?} \text{indicates text missing or illegible when filed}$$

Here, L_{A}(θ) is a loss function of the actor, [symbol] is a policy which is targeted by the actor, [symbol] is a gain function parameterized under [symbol] . The gain function [symbol] is a function which represents an expected gain obtained when an action a is taken in a given state s and is an indicator evaluating how much better a specific action (that is, an action of the actor which selects a specific compression rate) is than an average action. Accordingly, when a value of the specific action is higher than a value of the average action, a positive gain value (+) is obtained and when the value is low, a negative gain value (−) is obtained.

The gain function of Equation 2 is represented by the following Equation.

$${A}^{\text{?}} ( s , a ) = {Q}^{\text{?}} ( s , a ) - {V}^{\text{?}} ( s ) \qquad [ Equation 3 ]$$

$$\text{?} \text{indicates text missing or illegible when filed}$$

H ere, the Q term is an action-value function and represents an expected total reward which may be obtained when the specific action a is taken in the state s. For example, when the compression rate is selected, a gain to be obtained when a specific action such as selecting a specific compression rate is taken is predicted. The term V is a state-value function and represents an expected total reward which can be obtained in the state s. For example, it is predicted how much average gain is obtained by selecting a specific compression rate.

The loss function of the critic 312 is calculated by the following Equation.

$${L}_{C} ( ϕ ) = {E}_{\text{?}} \vert {( {R}_{t} + γ V ( {s}_{t + 1} , ϕ ) - V ( {s}_{\text{?}} , ϕ ) )}^{2} \vert \qquad [ Equation 4 ]$$

$$\text{?} \text{indicates text missing or illegible when filed}$$

Here, L_{C}(φ) is a loss function of a critic parameterized with φ, Rt is a reward at a timing t, γ is a discount factor, V(sₜ₊₁φ′) is a value of a next state estimated by a target network, V(sₜ,φ) is a value of a current state.

A total loss function of the agent 310 is calculated by the following Equation.

$${L}_{t} ( θ , ϕ ) = {L}_{A} ( θ ) + λ {L}_{C} ( ϕ ) \qquad [ Equation 5 ]$$

As represent in Equation 5, a total loss function is obtained by the loss function of the actor and the loss function of the critic to which a weight λ is applied. The reinforcement learning model is trained to find an optimal value through the gradient descent method using the total loss function Lₜ(θ, φ).

The reward R of Equation 4 is calculated by the following Equation.

$$R = [ \begin{matrix}\frac{1}{m} {\sum }_{i = 1}^{m} {( 1 - {\text{?}}_{i} )}^{2} , & y = \hat{y} \\ ρ , & otherwise\end{matrix} ] \qquad [ Equation 6 ]$$

$$\text{?} \text{indicates text missing or illegible when filed}$$

Here, m is a size of a data batch, a is an action taken by the agent, y is a class label, ŷ is a predicted class label, and ρ is a penalty value. According to Equation 6, if the class label matches based on the action (compression rate), the agent 310 receives a reward value in accordance with the compression value and if the class label does not match, the agent receives penalty.

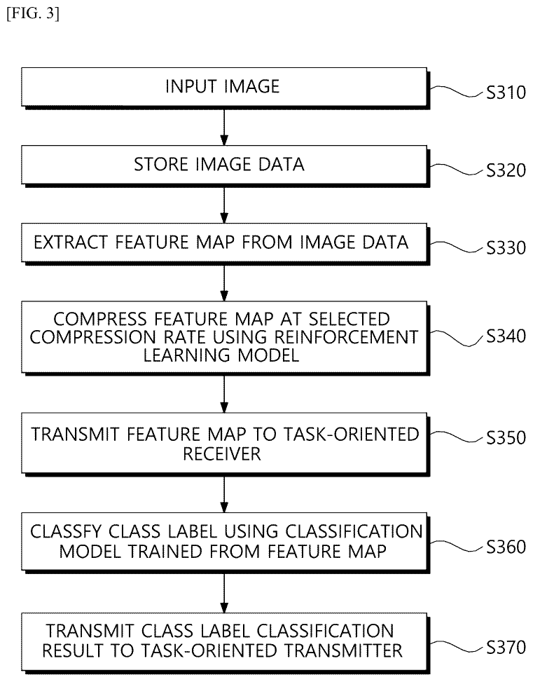

FIG. 3 is a flowchart of an operation method of a task-oriented communication system based on adaptive feature compression for a high efficient multimedia communication service, according to an exemplary embodiment of the present disclosure. An operation method of a task-oriented communication system according to the present exemplary embodiment is configured by steps processed in the above-described task-oriented communication system. Accordingly, even though it is omitted in the following description, the content described above is also applied to the operation method of a task-oriented communication system according to the present exemplary embodiment.

In step S310, the task-oriented transmitter 100 receives image data through the terminal sensor or the multimedia application.

In step S320, the task-oriented transmitter 100 stores image data.

In step S330, the task-oriented transmitter 100 extracts a feature map from image data using a convolutional neural network.

In step S340, the task-oriented transmitter 100 selects the compression rate using the reinforcement learning model trained by the learning unit 300 and compresses the feature map at the selected compression rate.

In step S350, the task-oriented transmitter 100 transmits the compressed feature map to the task-oriented receiver 200.

In step S360, the task-oriented receiver 200 classifies class labels using the classification model trained from the compressed feature map.

In step S370, the task-oriented receiver 200 transmits a class label classification result to the task-oriented transmitter 100.

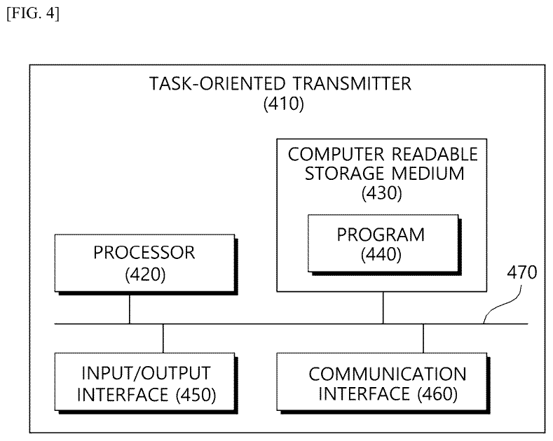

FIG. 4 is a block diagram of a task-oriented transmitter of a task-oriented communication system based on adaptive feature compression for a high efficient multimedia communication service, according to another exemplary embodiment of the present disclosure.

An operation method of a task-oriented communication system according to the exemplary embodiment of the present disclosure is performed by a task-oriented transmitter 410 of FIG. 4.

The task-oriented transmitter 410 includes at least one processor 420, a computer readable storage medium 430, and a communication bus.

The processor 420 controls the task-oriented transmitter 410 to operate. For example, the processor 420 may execute one or more programs stored in the computer readable storage medium 430. One or more programs may include one or more computer executable instructions and the computer executable instruction may be configured to allow the task-oriented transmitter 410 to perform the operations according to the exemplary embodiments when it is executed by the processor 420.

The computer readable storage medium 430 is configured to store a computer executable instruction or program code, program data and/or other appropriate format of information. A computer executable instruction or program code, program data and/or other appropriate type of information may also be provided by an input/output interface 450 or a communication interface 440. The program 430 stored in the computer readable storage medium 440 includes a set of instructions executable by the processor 420. In one exemplary embodiment, the computer readable storage medium 430 may be a memory (a volatile memory such as a random access memory, a non-volatile memory, or an appropriate combination thereof), one or more magnetic disk storage devices, optical disk storage devices, flash memory devices, and another format of storage media which are accessed by the task-oriented transmitter 410 and store desired information, or an appropriate combination thereof.

The communication bus 470 interconnects various other components of the task-oriented transmitter 410, including the processor 420 and the computer readable storage medium 430, to each other.

The task-oriented transmitter 410 may include one or more input/output interfaces 450 and one or more communication interfaces 440 which provide an interface for one or more input/output devices. The input/output interface 450 and the communication interface 440 are connected to the communication bus 470. The input/output device (not illustrated) may be connected to the other components of the task-oriented transmitter 410 by means of the input/output interface 450.

The processor 420 receives image data through the terminal sensor or the multimedia application.

The processor 420 stores input image data.

The processor 420 extracts the feature map using the convolutional neural network from the image data.

The processor 420 constructs and trains a reinforcement learning model for selecting a compression rate, using the image data.

The processor 420 selects the compression rate using the reinforcement learning model trained from the feature map and compresses the feature map at the selected compression rate.

The processor 420 transmits the compressed feature map to the task-oriented receiver 200 through the wireless network.

When the task-oriented receiver 200 classifies the class label using the classification model trained from the compressed feature map and transmits the class label classification result to the task-oriented transmitter 410, the processor receives the class label classification result.

The task-oriented transmitter and the task-oriented receiver may be implemented in a logic circuit by hardware, firm ware, software, or a combination thereof or may be implemented using a general purpose or special purpose computer. The task-oriented transmitter and the task-oriented receiver may be implemented using hardwired device, field programmable gate array (FPGA) or application specific integrated circuit (ASIC). Further, the task-oriented transmitter and the task-oriented receiver may be implemented by a system on chip (SoC) including one or more processors and a controller.

The task-oriented transmitter and the task-oriented receiver may be mounted in a computing device or a server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

In FIG. 3, the respective processes are sequentially performed, but this is merely illustrative and those skilled in the art may apply various modifications and changes by changing the order illustrated in FIG. 3 or performing one or more processes in parallel or adding another process without departing from the essential gist of the exemplary embodiment of the present disclosure.

The operations according to the exemplary embodiments of the present disclosure may be implemented as a program instruction which may be executed by various computers to be recorded in a computer readable medium. The computer readable medium indicates an arbitrary medium which participates to provide a command to a processor for execution. The computer readable medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The above description illustrates a technical spirit of the present invention as an example and various changes, modifications, and substitutions become apparent to those skilled in the art within a scope of an essential characteristic of the present invention. Therefore, as is evident from the foregoing description, the exemplary embodiments and accompanying drawings disclosed in the present disclosure do not limit the technical spirit of the present disclosure and the scope of the technical spirit is not limited by the exemplary embodiments and accompanying drawings. The protective scope of the present disclosure should be construed based on the following claims, and all the technical concepts in the equivalent scope thereof should be construed as falling within the scope of the present disclosure.

What is claimed is:

1. A task-oriented communication system, comprising:
a task-oriented transmitter, a task-oriented receiver, and a learning unit,
wherein the task-oriented transmitter includes:
an input unit which receives image data;
an extraction unit which extracts a feature map from the image data using a convolutional neural network;
a compression unit which compresses the feature map at a selected compression rate; and
a transmitter which transmits the compressed feature map to the task-oriented receiver,
the task-oriented receiver includes:
an inference unit which classifies a class label using a classification model trained from the compressed feature map; and
a transmitter which transmits a class label classification result to the task-oriented transmitter,
the learning unit trains a reinforcement learning model for selecting a compression rate, and the compression unit selects the compression rate using the trained reinforcement learning model.

2. The task-oriented communication system according to claim 1, wherein the reinforcement learning model includes an agent which selects a compression rate using an input feature map and an environment module which estimates an inference accuracy based on a feature map compressed at a compression rate selected by the agent to transmit a reward to the agent.

3. The task-oriented communication system according to claim 2, wherein the agent is trained based on the reward transmitted from the environment module using training errors of an actor and a critic.

4. The task-oriented communication system according to claim 3, wherein a loss function of the actor is calculated by the following Equation.
$${L}_{A} ( θ ) = - {E}_{\text{?}} \vert log {π}_{\text{?}} ( a \vert s ) {A}^{\text{?}} ( s , a ) \vert$$
$$\text{?} \text{indicates text missing or illegible when filed}$$
Here, L_{A}(θ) is a loss function of the actor, [symbol] is a policy which is targeted by the actor, and [symbol] is a gain function parameterized under [symbol] .

5. The task-oriented communication system according to claim 3, wherein a loss function of the critic is calculated by the following Equation.
$${L}_{C} ( ϕ ) = {E}_{\text{?}} \vert {( {R}_{t} + γ V ( {s}_{t + 1} , ϕ ) - V ( {s}_{\text{?}} , ϕ ) )}^{2} \vert$$
$$\text{?} \text{indicates text missing or illegible when filed}$$
Here, L_{C}(φ) is a loss function of a critic parameterized with φ, Rₜ is a reward at a timing t, γ is a discount factor, V(sₜ₊₁;φ′) is a value of a next state estimated by a target network, and V(sₜ,φ) is a value of a current state.

6. The task-oriented communication system according to claim 5, wherein the reward is calculated by the following Equation.
$$R = [ \begin{matrix}\frac{1}{m} {\sum }_{i = 1}^{m} {( 1 - {\text{?}}_{i} )}^{2} , & y = \hat{y} \\ ρ , & otherwise\end{matrix} ]$$
$$\text{?} \text{indicates text missing or illegible when filed}$$
Here, R is the reward, m is a size of a data batch, a is an action taken by the agent, y is a class label, ŷ is a predicted class label, and ρ is a penalty value.

7. The task-oriented communication system according to claim 1, wherein the learning unit is provided in an edge server.

8. An operation method of a task-oriented communication system which includes a task-oriented transmitter, a task-oriented receiver, and a learning unit, the operation method comprising the steps of:
receiving image data by the task-oriented transmitter;
extracting a feature map from the image data using a convolutional neural network;
compressing the feature map at a selected compression rate;
transmitting the compressed feature map to the task-oriented receiver;
classifying a class label using a classification model trained from the compressed feature map by the task-oriented receiver; and
transmitting a class label classification result to the task-oriented transmitter,
wherein the learning unit trains a reinforcement learning model for selecting a compression rate, and in the compressing step, the compression rate is selected using the trained reinforcement learning model.

9. The operation method of a task-oriented communication system according to claim 8, wherein the reinforcement learning model includes an agent which selects a compression rate using an input feature map and an environment module which estimates an inference accuracy based on a feature map compressed at a compression rate selected by the agent to transmit a reward to the agent.

10. The operation method of a task-oriented communication system according to claim 9, wherein the agent is trained based on the reward transmitted from the environment module using training errors of an actor and a critic.

11. The operation method of a task-oriented communication system according to claim 10, wherein a loss function of the actor is calculated by the following Equation.
$${L}_{A} ( θ ) = - {E}_{\text{?}} \vert log {π}_{\text{?}} ( a \vert s ) {A}^{zcode} ( s , a ) \vert$$
$$\text{?} \text{indicates text missing or illegible when filed}$$
Here, L_{A}(θ) is a loss function of the actor, [symbol] is a policy which is targeted by the actor, and [symbol] is a gain function parameterized under [symbol] .

12. The operation method of a task-oriented communication system according to claim 10, wherein a loss function of the critic is calculated by the following Equation.
$${L}_{C} ( ϕ ) = {E}_{\text{?}} \vert {( {R}_{t} + γ V ( {s}_{t + 1} , ϕ ) - V ( {s}_{\text{?}} , ϕ ) )}^{2} \vert$$
$$\text{?} \text{indicates text missing or illegible when filed}$$
Here, L_{C}(φ) is a loss function of a critic parameterized with φ, Rₜ is a reward at a timing t, γ is a discount factor, V(sₜ₊₁;φ′) is a value of a next state estimated by a target network, V(sₜ,φ) is a value of a current state.

13. The operation method of a task-oriented communication system according to claim 12, wherein the reward is calculated by the following Equation.
$$R = [ \begin{matrix}\frac{1}{m} {\sum }_{i = 1}^{m} {( 1 - {\text{?}}_{i} )}^{2} , & y = \hat{y} \\ ρ , & otherwise\end{matrix} ]$$
$$\text{?} \text{indicates text missing or illegible when filed}$$
Here, R is the reward, m is a size of a data batch, a is an action taken by the agent, y is a class label, ŷ is a predicted class label, and ρ is a penalty value.

14. A computer program stored in a computer readable storage medium to allow a computer to execute the operation method of a task-oriented communication system according to claim 8.

15. A task-oriented transmitter of a task-oriented communication system, comprising:
a processor; and
a memory in which a program executed by the processor is stored,
wherein the processor is configured to
receive image data,
extract a feature map from the image data using a convolutional neural network,
train a reinforcement learning model for selecting a compression rate,
select a compression rate using the trained reinforcement learning model,
compress the feature map at the selected compression rate,
transmit the compressed feature map to the task-oriented receiver,
classify a class label using a classification model trained from the compressed feature map by the task-oriented receiver; and
receive the class label classification result when the class label classification result is transmitted.
